(19) United States
(12) Patent Application Publication
(10) Pub. No.: US 2008/0224809 A1
(43) Pub. Date: Sep. 18, 2008

(54) MAGNETIC INTEGRATION STRUCTURE

(75) Inventors: Yanjun ZHANG, Hangzhou City (CN); Dehong Xu, Hangzhou City (CN); Kazuaki Mino, Tokyo (JP); Kiyoaki Sasagawa, Tokyo (JP)

Correspondence Address: RABIN & Berdo, PC, 1101 14TH STREET, NW, SUITE 500, WASHINGTON, DC, 20005, US

(73) Assignees: ZHE JIANG UNIVERSITY, Zhejiang Province (CN); FUJI ELECTRIC SYSTEMS CO., LTD., Tokyo (JP)

(21) Appl. No.: 12/033,888

(22) Filed: Feb. 19, 2008

Related U.S. Application Data
(63) Continuation-in-part of application No. PCT/CN2007/000592, filed on Feb. 17, 2007.

(30) Foreign Application Priority Data
Aug. 28, 2007 (CN) 200710070573.1
Nov. 16, 2007 (CN) 200710186467.X

(51) Int. Cl. H01F 27/28

(52) U.S. Cl. 336/170

(57) ABSTRACT

A magnetic part having a first iron core wound with a winding constituting a transformer and an inductance component of a parallel coil and a second iron core wound with an inductance component of a series coil, in which a ratio of the dimensions of the first iron core and the second iron core are in accordance with their respective winding densities.

### CROSS-REFERENCE TO RELATED APPLICATIONS

This application is a continuation-in-part of International Patent Application PCT/CN2007/000592, filed on Feb. 17, 2007, designating the United States, and is based on, and claims priority under the Paris Convention from, International Patent Application PCT/CN2007/000592, filed on Feb. 17, 2007, Chinese Patent Application 200710070573.1, filed on Aug. 28, 2007, and Chinese Patent Application 200710186467.X, filed on Nov. 16, 2007, the contents of which are incorporated herein by reference.

### BACKGROUND ART

1. Field of Invention

The invention relates to a magnetic part integrating a transformer and a coil.

2. Background of the Invention

FIG. 5 shows an example of a circuit based on the background art. The example is an insulating type DC-DC converter capable of insulating a voltage of a direct current power source 1 and outputting a direct current voltage to a load 11. Further, a resonating operation is constituted by a capacitor 4, a series coil 5, and a parallel coil 6, and therefore, switching elements 2, 3 and diodes 8, 9 are operated by a software switching operation to reduce a switching loss.

FIG. 6 shows an example of integrating magnetic parts of the coils 5, 6 and a transformer 7 of FIG. 5. Here, a primary winding 12, a secondary winding 13, and a tertiary winding 14 of the transformer are wound around one of three supports formed by a pair of E-type cores (hereinafter, referred to as “EE core”). By constituting the secondary winding 13 and the tertiary winding 14 of the transformer on a path of magnetic flux the same as that of the primary winding 12 of the transformer, the primary winding 12, the secondary winding 13 and the tertiary winding 14 are magnetically coupled and the transformer can be formed. Here, the parallel coil 6 is also formed simultaneously by the primary winding 12 of the transformer, and by changing the number of turns of the primary winding 12 and the length of the air gap 16, the inductance of the parallel coil 6 can be adjusted. A magnetic flux generated by applying a voltage to the primary winding 12 extends along a path designated by arrow mark 18 in FIG. 6. Further, a winding of the primary winding 12 is wound also around another support in series as in a winding 15 of the coil to form the series coil 5. Also the inductance of the series coil 5 similarly can be adjusted by setting the number turns of the winding 15 of the coil and the length of the air gap 17. Here, a magnetic flux generated by making a current flow in the winding 15 of the coil extends along a path indicated by the arrow mark 19 in FIG. 6 to constitute a direction inverse to that of the magnetic flux 18 generated by the primary winding 12 of the transformer at a support of the center portion. Therefore, the magnetic flux is reduced at the support of the center portion to reduce iron loss. By using such a technology, the transformer 7, and the coils 5, 6 can be integrated as a single part to be able to achieve a small-sized and low cost formation. The publication, Bo Yang, Rengang Chen, F. C. Lee, “Integrated Magnetic for LLC Resonant Converter”, IEEE APEC 2002, pp. 346-351 discloses such a construction.

Further, FIG. 7 shows a technology of integrating the transformer 7 and the coils 5, 6 shown in FIG. 5 by inserting an I-type core between one E-type core and another E-type core of an EE-core. Here, an I type core 24 is inserted between two of E-type cores 21 and 22 and the primary winding 12, the secondary winding 13, the tertiary winding 14 are wound around a support of a center portion of the E-type core 21, and the winding 15 of the coil 5 is wound around a support of a center portion of the E-type core 22. Similar to FIG. 6, also in FIG. 7, by winding the primary winding and the secondary winding and the tertiary winding of the transformer on the same magnetic path, the primary winding and the secondary winding and the tertiary winding are magnetically coupled to be operated as the transformer. Further, the inductance of the parallel coil 6 can be adjusted by adjusting the number of turns of the primary winding 12 of the transformer and the length of the air gap 17. A magnetic flux generated by applying a voltage to the primary winding 12 of the transformer constitutes a path indicated by the arrow mark 18, and a magnetic flux generated by making a current flow in the winding 15 of the coil creates a path of the magnetic flux 19. Here, at the inside of the I-type core, the magnetic flux 18 and the magnetic flux 19 are in directions to canceling each other, a magnetic flux density is reduced and also iron loss is reduced. By using such a technology, the transformer 7 and the coils 5, 6 can be integrated as a single part to be able to achieve a small-sized and low cost formation.

In FIG. 6, a portion of connecting the two E-type cores is constituted only by the support of the center portion, and a fixing portion is constituted by a single portion, and therefore, the portion becomes physically unstable. Therefore, there is a high likelyhood of being destroyed by a physical vibration or an impact, and the reliability is deteriorated. Further, whereas the primary winding 12, the secondary winding 13 and the tertiary winding 15 are formed at a winding space of the first iron core for constituting the transformer (here, the left side of FIG. 6), only the winding 15 of the coil is constituted at a winding space of the second iron core for constituting the series coil 5 (here, the right side of FIG. 6). Normally, whereas the winding of the primary winding 12 of the transformer needs to be wound 10 to 20 times, the winding 15 of the coil may be wound by about 1 to 5 times. Therefore, the winding density is large on the side of the transformer for constituting a number of windings, and windings become sparse on the side of the series coil 5. In order to constitute the number of turns necessary for the winding space on the side of the transformer, the windings need to be slender, the winding resistance is increased, and copper loss is increased. On the other hand, in order to make the windings bold to reduced copper loss, the winding space needs to be increased (the core shape needs to be enlarged) to be able to ensure the number of turns necessary for the side of the transformer, the magnetic parts are larged, and cost is increased.

In FIG. 7, the E-type core and the I-type core are connected by supports on both sides, and therefore, the construction is physically stable in comparison with FIG. 6, and strong at impact or vibration and reliability is high. However, similar to FIG. 6, a winding density on the side of the transformer is large, and windings on the side of the series coil 5 becomes sparse. Therefore, the winding density is large on the side of the transformer constituting a number of windings, and the windings becomes sparse on the side of the series coil 5. In order to constitute the turn number necessary for the winding space on the side of the transformer, the windings need to be slender, the winding resistance is increased, and copper loss is increased. On the other hand, in order to make the windings bold and reduce copper loss, the winding space needs to be increased (core shape needs to be enlarged) to be able to ensure the turn number necessary on the side of the transformer, magnetic parts are large-sized and cost is increased.

### SUMMARY OF THE INVENTION

The invention has been carried out in order to resolve the above-described problem of the background art, the invention described in Claim 1 is characterized in a magnetic integration structure, wherein in a magnetic part including a first iron core wound with a winding constituting a transformer and an inductance component of a parallel coil and a second iron core wound with an inductance component of a series coil, a ratio of dimensions of the first iron core and the second iron core are set in accordance with winding densities.

In a first embodiment of the invention, the first iron core may be formed by an E-type core and an I-type core and the second iron core is formed by other E-type core and an I-type core shared by the first iron core (the invention described in Claim 2).

In a further embodiment of the invention, the first iron core may be formed by an E-type core and an I-type core and the second iron core may be formed by other E-type core.

In yet a further embodiment, the first iron core may be formed by a pair of E-type cores and the second iron core may be formed by one E-type core of the pair of E-type cores and other E-type core connected to the one E-type core (the invention described in Claim 4), and an outer shape of the other E-type core may be the same as an outer shape of the one E-type core of the pair of E-type cores.

Furthermore, the ratio of dimensions may be constituted by lengths of the iron cores or widths of the iron cores, the winding density may be determined by the number of turns of the winding, the thickness of the winding, the length of the winding, or the material of the winding.

By the invention, the ratio of dimensions of the iron core on the side of the transformer (first iron core) and the iron core on the side of the series coil (second iron core) can be set in accordance with the winding density, the winding does not need to be slender, and therefore, copper loss can be reduced. Further, the winding space on the side of the series coil can be reduced, and therefore, a magnetic member of a magnetic part can be reduced, and a small-sized and low cost formation can be achieved.

### BRIEF DESCRIPTION OF THE DRAWINGS

FIG. 1 is a conceptual view of a magnetic part showing one embodiment of the invention.

FIG. 2 is a conceptual view of a magnetic part showing another embodiment of the invention.

FIG. 3 is a conceptual view of a magnetic part showing a further embodiment of the invention.

FIG. 4 is a conceptual view of a magnetic part showing still another embodiment of the invention.

FIG. 5 is a circuit diagram showing an example of applying the background art to a DC-DC converter.

FIG. 6 is a conceptual view of a magnetic part showing an structure based on a background art.

FIG. 7 is a conceptual view of a magnetic part showing another structure based on a background art.

### DETAILED DESCRIPTION OF THE PREFERRED EMBODIMENTS

A winding space on a side of a transformer needing a large winding space is increased and a winding space on a side of a series coil needing only a small winding space is reduced. Thereby, windings on a side of the transformer can be constituted by a pertinent winding thickness, and copper loss can be reduced. Further, by adjusting the winding space to the necessary winding space, the amount of material of a magnetic member is reduced and a small-sized and low cost formation is achieved.

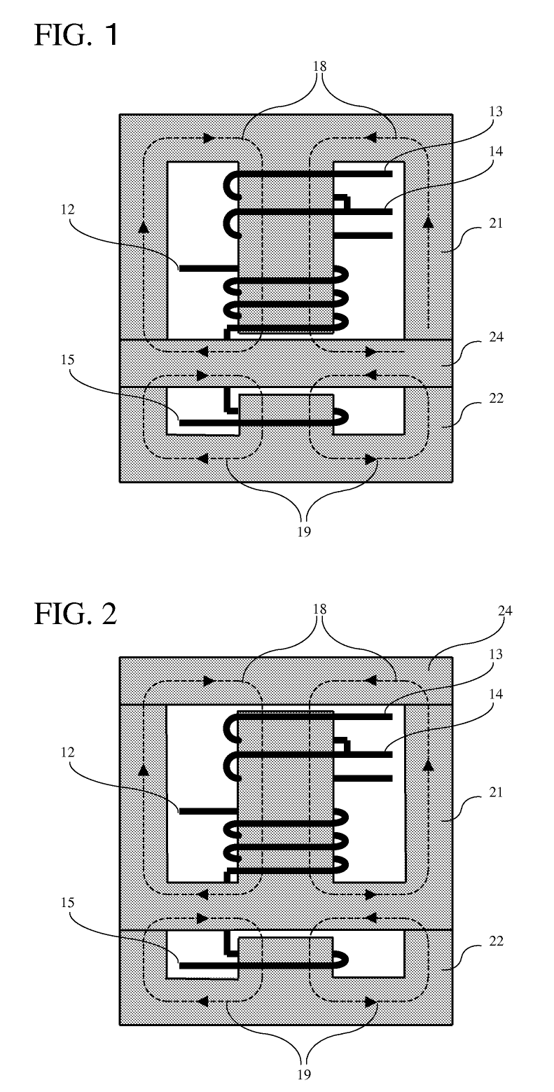

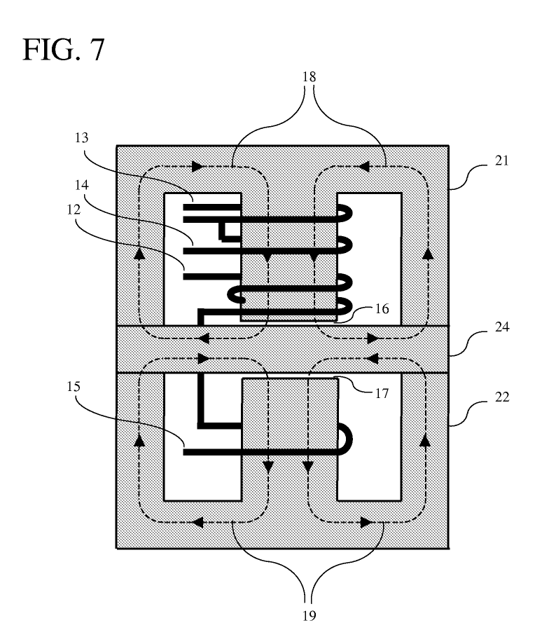

FIG. 1 shows one embodiment of the invention. According to this embodiment, similarly to the background art shown in FIG. 7, the core is fixed at two portions of supports on both sides, and therefore, the embodiment is physically solid, strong in response to impact or vibration and the reliability thereof is high. Further, the winding space constituting the winding 15 on a side of the series coil 5 is reduced, and a space constituting the windings 12, 13, 14 of the transformer of the parallel coil is increased. In other words, a ratio of dimensions of the iron core on the side of the transformer (first iron core) and the iron core on the side of the series coil (second iron core) is set in accordance with a winding density. Thereby, the winding of the transformer, which can be formed only by a slender winding in the background art, can be made to be thick and the copper loss can be reduced. Here, even when the winding space on the side of the transformer is increased, the winding space on the side of the series coil is reduced, and therefore, magnetic parts do not become large. Conversely, they can be small-sized since the respective winding spaces can optimally be adjusted. Further, by optimally adjusting the respective winding spaces, the amount of material of a magnetic member can be reduced, and therefore, a low cost formation can be achieved. Incidentally, the magnetic flux 18 generated on the side of the transformer and the magnetic flux 19 generated on the side of the series coil 5 are in opposite directions for canceling each other, and therefore, there is constructed a structure that makes full use of the advantage of the background art as it is and a reduction in the loss, and a small-sized and low cost formation can further be achieved.

FIG. 2 shows another embodiment to construct a structure of connecting the E-type core to an EI-type core. Operation and effect are similar to those of Claim 1.

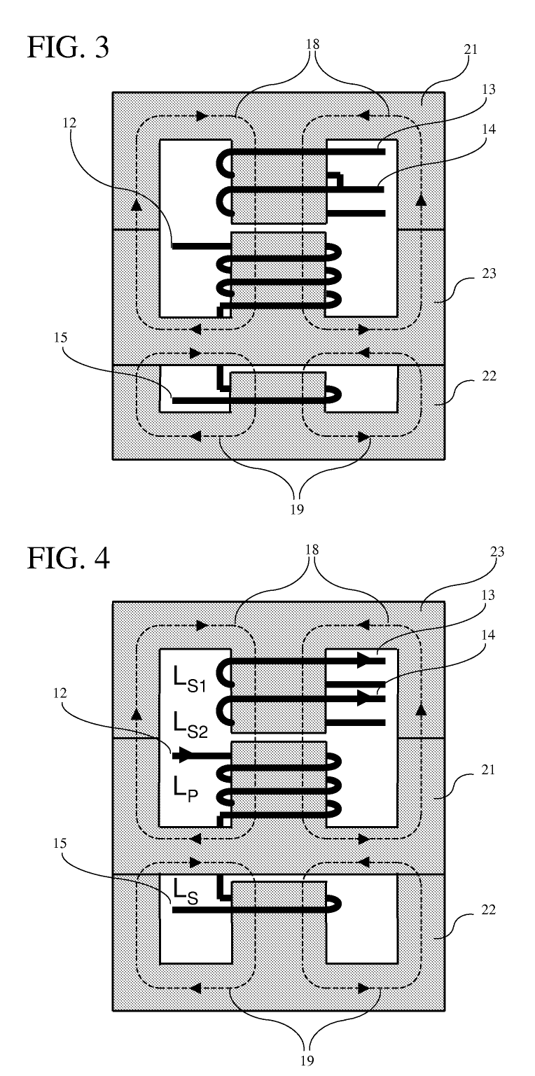

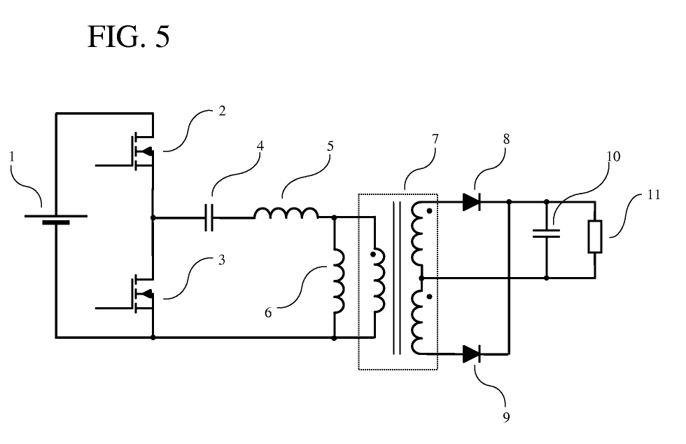

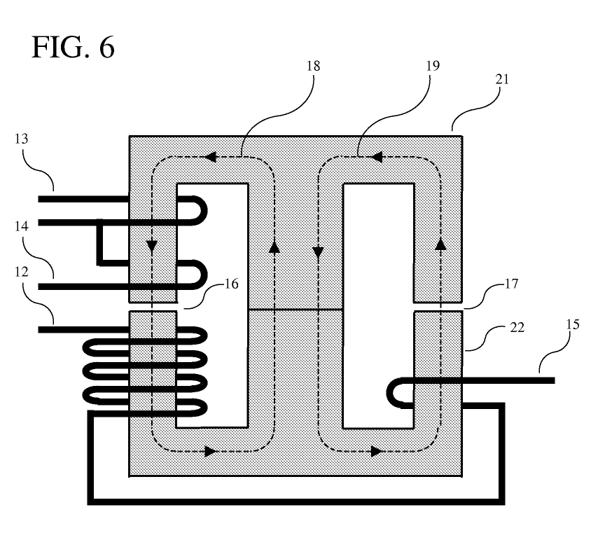

FIG. 3 shows an additional embodiment of the invention. Here, there is constructed a construction of connecting three of E-type cores to realize a form similar to that of the first-described embodiment of FIG. 1. Also, operation and effect thereof are similar to those of the FIG. 1 embodiment.

In FIG. 4, there is shown a construction using three of E-type cores having the same outer shape dimension. By using the cores having the same outer shape, a winding space on the side of the transformer becomes twice as much as a winding space on the side of the series coil, the winding space on the side of the transformer can be increased and the winding space on the side of the series coil 5 can be reduced. Therefore, an effect similar to the FIG. 1 embodiment is achieved. Further, the construction can be formed by using one kind of the core, and therefore, the kind of die and the process for fabricating the core can be simplified, and the fabrication cost can be reduced. Further, by purchasing three EE-type cores, two of the integrated magnetic parts can be fabricated, and therefore, the structure can be fabricated by with a inexpensive standard product without using a special order product.

Further, in the above-described embodiment, the ratio of dimensions of the iron core on the side of the transformer (first iron core) and the iron core on the side of the series coil (second iron core) may be determined by lengths of the iron cores, or by widths of the iron cores. Further, the winding density may be constituted by the number of turns of windings for adjusting the inductance, or by a thickness in consideration of the thickness of a coating of the winding in accordance with a requested insulation withstand voltage level, the length of the winding, or the material of the winding. With regard to the material of the winding, the material effects an influence upon the number of turns or the space by a hardness or insulating performance.

The invention is provided with a possibility of being applied to a converting circuit using a transformer or a coil, for example, a DC-DC converter.

What is claimed is:

1. An integrated magnetic structure comprising a magnetic part including:
a first iron core wound with a transformer winding and wound with an inductor component connected in parallel with the transformer winding; and
a second iron core wound with an inductance component connected in series with the transformer winding, wherein
a ratio of dimensions of the first iron core and the second iron core is set in accordance with respective winding densities of the first iron core and the second iron core.

2. The integrated magnetic structure according to claim 1, wherein
the first iron core is formed by a first E-type core and an I-type core, and
the second iron core is formed by a second E-type core and the I-type core.

3. The integrated magnetic structure according to claim 1, wherein the first iron core is formed by an E-type core and an I-type core, and the second iron core is constituted by a second E-type core.

4. The integrated magnetic structure according to claim 1, wherein:
the first iron core is formed by a pair of E-type cores; and
the second iron core is formed by a first E-type core of the pair of E-type cores and a second E-type core of the pair of E-type cores connected to the first E-type core.

5. The integrated magnetic structure according to claim 4, wherein an outer shape of the second E-type core is the same as an outer shape of the first E-type core.

6. The integrated magnetic structure according to claim 1, wherein the ratio of dimensions is a ratio of respective lengths of the first and second iron cores.

7. The integrated magnetic structure according to claim 1, wherein the ratio of dimensions is a ratio of respective widths of the first and second iron cores.

8. The integrated magnetic structure according to claim 1, wherein the respective winding densities are each defined as a number of turns of a respective winding.

9. The integrated magnetic structure according to claim 1, wherein the respective winding densities are each defined as a thickness of a respective winding.

10. The magnetic integration structure according to claim 1, wherein the respective winding densities are each defined as a length of a respective winding.

11. The magnetic integration structure according to claim 1, wherein the respective winding densities are each defined by the material of a respective winding.
